(19) United States
(12) Patent Application Publication
(10) Pub. No.: US 2014/0282891 A1
(43) Pub. Date: Sep. 18, 2014

(54) METHOD AND SYSTEM FOR UNIQUE COMPUTER USER IDENTIFICATION FOR THE DEFENSE AGAINST DISTRIBUTED DENIAL OF SERVICE ATTACKS

(71) Applicant: Stephen Frechette, Newton, MA (US)

(72) Inventor: Stephen Frechette, Newton, MA (US)

(21) Appl. No.: 13/831,659

(22) Filed: Mar. 15, 2013

(51) Int. Cl. H04L 29/06

(52) U.S. Cl. CPC H04L 63/08
USPC 726/4

(57) ABSTRACT

The improvement invention is a means to prevent successful Distributed Denial of Service attacks via a decentralized user Internet Protocol (IP) validation method. The invention is an improvement on a method and system for the validation that a unique computer user is in control of a computer that is capable of performing a non-trivial amount of calculations on command. By ensuring a user is in command of a computer that requests a service, and that the computer will perform a non-trivial task on-demand, a cost is incurred by that client computer, and thus decreases the likelihood of large-scale successful DDoS attacks by swarms of botnets.

### BACKGROUND OF THE INVENTION

1. Field of the Invention

The improvement invention is a means to prevent successful Distributed Denial of Service, DDoS, attacks via a decentralized user Internet Protocol (IP) validation method. The invention solves the following problem:

DDoS attacks upon transaction-based Internet applications prevent non-malicious users from accessing transaction-based Internet applications. The model of the transaction consists of an open set of users located anywhere on the Internet, and an Internet application that provides time sensitive transactions, or services, to the users. A common defense mechanism, the use of caching, is not possible for transaction-based Internet applications, because each user of the application requires a timely and unique service, e.g., a stock purchase. Since transaction-based Internet applications cannot employ caching, i.e., data replication as a defense mechanism, transaction-based Internet applications are significantly more difficult to defend against DDoS attacks than standard download-only based Internet applications.

Successful DDoS attacks occur when a service offered by a remote computer is not accessible to a majority of users due to a large volume of malicious resource consuming requests. This invention solves the problem by requiring all users to perform computations that would consume a significant amount of the client's resources for a small period of time, thus greatly reducing the volume of malicious resource requests. The computations that the computer must perform requires the use of an open, i.e., running web browser.

The improvement invention reduces the volume of malicious requests through a forced validation step, in which the user that requests the service must perform an action that requires a significant amount of computations and resource usage on the user(s)/client(s) computer/machine. The significant amount of calculations required by the challenge-response authentication greatly reduces the volume of malicious users by requiring both a time and computational cost incurred by the user(s)/client(s) computer/machine.

2. Description of Prior Art

In previous art, Completely Automated Public Turing test to tell Computers and Humans Apart, CATSPA's, have been employed as a challenge-response to ensure that a human is in control of a client machine, as oppose to an automated script or Bot. The invention in this application is a challenge-response that does not require human action other than to access a certain webpage. The challenge-response is performed by a web-browser that may consume a significant amount of computational resources on the client machine and is able to thus answer the challenge question.

The invention differs from previous art in that unlike previous art that employs a challenge-response method or a puzzle solving action for the prevention of DDoS attacks, the invention is decentralized and relies on only file cache servers to provide client machines a challenge question to answer/respond to. Also, only static .html files are served to clients. The log files of the file cache servers are analyzed and clients that successfully answer their challenge question, with a challenge response, are only then allowed access to an ingress node of the proxy network. The validated user enters via an ingress point of the proxy network and reaches the transaction-based server, only after the client has successfully passes the challenge-response test. A malicious user of software in control of a victim client could answer the challenge-response correctly, but this process is made difficult because it would require the malicious user to either install and execute a program designed to answer the specific challenge question, or open up a web browser window on the victim client machine, in order to answer the challenge-response correctly.

The IP of the transaction-based server machine is hidden from the user and is only available to the proxy server. Unlike previous art in which malicious requests are filtered via inspection, the presented invention filters malicious requests by requiring all requests to perform an action that consumes a significant amount of resources of an active web-browser application for a small period of time, thus reducing the number of malicious resource requests that reach the transaction-based server.

Prior art employs puzzle-action or challenge-response authentication of unique users via the requirement of calculations, or puzzles to by solved, by the user(s)' computer/machine. The invention presented in this application provides a distributed and scalable manner for challenge-response authentication that does not require action by the user, and is distributed in a manner that all components can be replicated and are thus scalable. Unlike prior art, in this invention the entire process of serving challenge-response is provided in a distributed manner.

### BRIEF SUMMARY OF THE INVENTION

The improvement invention forces a cost onto the user of a web server, in the form of performing a non-trivial computation as a validation step in order to access the transaction-based web server. This step thus filters out many forms of DDoS attacks, because the attacker must be in control of a web browser in order to perform the non-trivial computation. The improvement invention differs from other rendezvous-based DDoS attack methods and challenge-response authentication systems, in that the users/clients are provided with a static .html file via a distributed content distribution system that automatically scales to meet the demand of all the users. The static .html file contains Javascript code that executes on the user/client's machine and the results answer the challenge-response question. The answer is returned in the form of an URL address that contains a filename that includes a key that is the answer to the challenge response question. Upon requesting that particular filename, the retrieved .html code redirects the user to the proxy server/router, which then allows the validated user through the web server.

The Javascript code that executes on the client's machine should be updated periodically on the servers which serve the static .html file with the embedded Javascript. The Javascript requests an answer to a challenge question, which may be a computationally intensive mathematical problem, or any Javascript code that requires execution in a web-browser, and can be solved via Javascript that is running in a browser. Additional checks within the challenge question ensure that the Javascript is actually running within a web-browser, i.e., the details of the browser and other hardware and software setting as determined by commands executed on the web-browser.

The invention is an improvement on previous challenge-response authentication systems. In this invention the cache server(s) and proxy server(s)/router(s) automatically scale due to demand. Since the entire system is decentralized, the file cache servers and proxy servers can operate on several platforms. Additionally, through the use of multiple ingress points to the network, which can scale due to demand/usage of proxy server(s)/router(s), attackers/malicious-users would not be able to flood and overwhelm the available bandwidth of all the routes to the transaction-based web server. Lastly, the user is never provided with the true IP address of the transaction-based web server, they are only provided with the IP address of the proxy server(s)/router(s).

The uses of the invention include but are not limited to the following scenario:

Users need to access transaction-based web services in the presents of malicious users of those same transaction-based web services. All Users must first pass a challenge-response authentication step. Once the user passes the authentication process, the Users are redirected to proxy server(s)/router(s). If the Users pass the authentication, then the Users are then passed through the proxy server(s)/router(s) to the transaction-based web server.

### BRIEF DESCRIPTION OF THE DRAWINGS

FIG. 1 is a diagram that illustrates the distribution of a challenge question to Users/Clients, which are also shown in FIGS. 2 and 3.

FIG. 2 is a flow diagram that illustrates the challenge-response mechanisms within the invented method for User/Client validation.

FIG. 3 is a flow diagram of the access control of an exemplary method for User/Client validation in a manner consistent with the presented invention.

FIG. 4 is exemplary information contained within the challenge question and response, which is displayed in communications in FIG. 2.

FIG. 5 is a diagram of an exemplary apparatus that may perform various operations in a manner consistent with the presented invention.

### DETAILED DESCRIPTION OF THE INVENTION

The improvement invention allows for non-malicious User(s) 100 of a Transaction-based server 160 to access and use it in the presence of malicious attackers that are trying to commit a successful DDoS attack upon the Transaction-based web server 160. Firstly, the User enters a URL in their web browser, e.g., www.pets.com. Next, the DNS provides the user with the IP address of a scalable network of static .html files that due to the automatic scaling, redundancy, and bandwidth is virtual unable to ever be brought down by a DDoS attack, e.g., Amazon Simple Storage Service, Amazon S3, Content distribution network. The .html file sent to the user by 110 contains Javascript code that is run/executed on the User's client machine 100. The challenge response 102 is answered by the Javascript code running on the client's machine 100. The challenge response 102 is passed to a file server 110 in the form of a request for an additional file with the name of the file as the answer to the challenge response 102. The server access log may be in the format of Amazon S3's content distribution network, and thus the time, IP of the client, User ID of the client, and URL requested are recorded and are accessible.

The response to the challenge question is recorded by the Server Access Log 120; which is thus a record of a certain User's client machine's 100 IP address returning a correct response to a challenge question 101. Therefore a User 100 has proven they are in control of a client machine and can perform a non-trivial amount of computations, and the last of the two files read from the file server 110, contains Javascript code within the static .html file that routes them to one of a multitude of Proxy Server(s)/Router(s) 130.

By requiring all Users 100 to perform a non-trivial amount of computation, i.e., correctly answer the challenge response question, a cost is thus required by the User 100. If the correct response is provided, the User 100 is added to the Access Control List 140 of the Proxy Server/Router 130. Now the User 100 is routed through the Proxy server/router 130, to the Transaction-based web server 160.

Since the User 100 must receive the challenge question and respond to it from the same source IP address, the system exhibits an inherent defense against IP spoofing. This is because if the IP address was spoofed, it could not receive traffic from the static file server 110, which provides the challenge question, and also records the response, which must be from an IP address that requested the challenge question.

FIG. 1 is a diagram that illustrates the distribution of a challenge question to Users/Clients. The User 100 reads a static .html file 115 that contains a challenge question. A response answer is provided in the form of a file name that is requested from the static file server 110, via a URL request. Once the User(s)/Client(s) have successfully answered the challenge question, they are directed to the Proxy Server(s)/Router(s) 130. If the Server(s)/Router(s) has the User(s)/Client(s) on the access control list, then the user is routed through 130 to the Transaction-Based Server (server machine) 160.

FIG. 2 is a flow diagram that illustrates the challenge-response mechanisms within the invented method for User(s)/Client(s) validation. The User(s)/Client(s) 100 validation process starts first when a User 100 requests a file from the file cache server 110, which servers a Challenge Question 101 to the User 100. The User 100 then answers the Challenge Question and returns a Challenge Response 102, which takes the form of a URL, in which the answer is included in the URL. A Challenge-Response Validation mechanism 150 reads the Server Access Log 120. If a User(s)/Client(s) IP address is shown in the Server Access Log 120 as reading a Challenge Question and a successful read of a Challenge Response, i.e., the correct answer is provided, which is performed by a URL request with the answer embedded in the string, then the User's IP is added to the Access Control List 140. Access to the Proxy Server(s)/Router(s) are controlled by the Access Control List 140.

At the instruction of the File Cache Server 110 the User(s)/Client(s) are directed to the Proxy Server(s)/Router(s), and if they are on the Access Control List 140 then the traffic is forwarded through the proxy 130 to the Transaction-Based Web Server or Web Service 160.

FIG. 3 is a flow diagram of the access control of an exemplary method for User/Client validation in a manner consistent with the present invention. Firstly, User(s)/Client(s) 100, via a URL request, are directed by the DNS CNAME conversion to the Static File Cache Server 110. If the User(s)/Client(s) 100 pass the challenge-response test, as performed by the Challenge-Response Validation 150, which reads the Access Log 120 and returns the IP of the validated User(s)/Client(s) to the Access Control List 140 of the Proxy Server(s)/Router(s) 130, then the User(s)/Client(s) 100 traffic is passed through 130 to the to the Transaction-Based Web Server 160.

FIG. 4 illustrates the challenge-response information, which is also illustrated in FIG. 2. The information is displayed in the Challenge Question 101 and Challenge Response 102.

FIG. 5 is a high level diagram of a machine that may perform one or more of the operations discussed above. A machine is required to implement the following mechanisms, User(s)/Client(s) 100, Static File Cache Server 110, Proxy Server(s)/Router(s) 130, and Transaction-Based Web Server 160.

The improvement invention requires the use of a machine to store data, accept inputs from the User(s)/Client(s), output data to a human readable display, and connect to servers (other machines) over the Internet. The servers have the same requirements as the previously describe machine except the inputs, outputs, and displays are provided through a network connection and the input/output is performed on another machine connected to the network. The machine may be a server or router or network attached storage device, or any machine capable of accessing a server and which includes one or more processors 510, storage devices 520, one or more input/output interface unites 530, and one or more system buses and/or networks 540 for facilitating the communication of information among the coupled elements. The machine must also contain one or more input devices 532 and one or more output devices 534 that may be coupled with the one or more input/output interfaces 530. The output devices 534 may include a monitor or cell phone display screen or other type of display device, which may also be connected to the system bus 540 via an appropriate interface. The processors 510, may execute any number of possible operating systems, including but not limited to Linux, Solaris, Windows-based, Android, iOS, webOS, and any other operating system capable of supporting a web-browser either on a cell phone, personal computer, server, web-enabled television, or any other device capable of displaying a web page on the Internet.

1. A computer-implemented method for user authentication, in which the user is in control of a computer/machine that is capable of performing computations at the command of the user and displaying images to the user via a computer screen, wherein the improvement comprises the following steps:
a) commanding, by a computer system or cell phone, internet address information associated with the request;
b) calculations, by the client's computer system or cell phone, authentication challenge question provided by the file cache server, and passing the answer via another URL request to the file cache server;
c) controlling, by the file cache server(s), the address of the proxy server(s)/router(s) that the users are forwarded to via a command from the file cache server;
d) determining, by the proxy server(s)/router(s), whether the user answered the challenge-response authentication correctly;
e) forwarding, by the proxy server(s)/router(s), of the user(s)' web traffic to the transaction-based web server; and
f) if the previous steps a through e are performed, maintaining a connection from the user to proxy server(s)/router(s) and on to the transaction-based web-server, in which the user never knows the true IP of the transaction-based web server.
g) if the previous steps a through e are performed, servicing and routing all connections from the previously authenticated user's IP address to proxy server(s)/router(s) and on to the transaction-based web-server, in which the user never knows the true IP of the transaction-based web server.

2. The method of claim 1, wherein the improvement comprises the step of the creation of a multitude of paths exist from the user(s)' IP address to a multitude of to proxy server(s)/router(s) that may route the users traffic to a transaction-based web-server, in which the user never knows the true IP of the transaction-based web server.

3. The method of claim 1, wherein the improvement comprises the step of unique-user authentication for determination that a human user is in control of an apparatus comprising:
a) at least one processor; and
b) at least one storage device storing processor-executable instructions which, when executed by at least one processor, perform a method of:
1) accepting information (the challenge-question) at the request of the user from file cache server,
2) calculating information (the answer to the challenge-question, or the challenge-response) at the request of the user,
3) delivering the information (the answer to the challenge-question, or the challenge-response) at the request of the user to the file cache server,

4. The apparatus of claim 1, wherein the improvement comprises the step of a client connecting to a proxy server(s)/router(s) apparatus for routing traffic from approved user IP addresses wherein the method comprises the following steps:
a) at least one processor; and
b) at least one storage device storing processor-executable instructions which, when executed by at least one processor, perform a method of:
1) automatically generating static .html files and push them up to the file cache servers from and by the proxy server(s)/router(s)
2) automatically monitoring access logs of the file cache servers from and by the proxy server(s)/router(s)
3) automatically maintaining and access control list of approved user IP addresses that correspond to users that have passed the challenge-response authentication, for access through the proxy server(s)/router(s) to the transaction-based web server.
3) hiding the true IP address of the transaction-based web server from the user.

5. The apparatus of claim 1 wherein the improvement comprises the step of a client connecting to a transaction-based web server apparatus for serving users comprises the following method:
a) at least one processor; and
b) at least one storage device storing processor-executable instructions which, when executed by at least one processor, perform a method of:
1) accepting traffic and connections from only approved IP addresses that correspond to proxy server(s)/router(s)
2) automatically monitoring access logs of the file cache servers from and by the proxy server(s)/router(s)
3) automatically maintaining and access control list of approved user IP addresses that correspond to users that have passed the challenge-response authentication, for access through the proxy server(s)/router(s) to the transaction-based web server.

6. The apparatus of claim 1 wherein the improvement comprises the step of a client connecting to a file cache server(s) apparatus that may replicate and scale up to any number of machines.

7. The apparatus of claim 1 wherein the improvement comprises the step of a client connecting to a proxy server(s)/router(s) apparatus that may replicate and scale up to any number of machines.

8. The apparatus of claim 1 wherein the improvement comprises the step of a landing site for a static URL, that begins with the string www, which is accessible in a content distribution network that is provided by a Domain Name Server, DNS, which contains embedded Javascript code that acts as a challenge-response question executed only by the client.

9. The apparatus of claim 1 wherein the improvement comprises the step of a landing site for a static URL accessible in a content distribution network that is provided by a Domain Name Server, DNS, in which the content distribution network that serves the static .html code with embedded Javascript records a server access log that notes the reception of the correct answer to the challenge-response question that is within the Javascript embedded in the static .html code, via a URL request.

10. The apparatus of claim 1 wherein the improvement comprises the step of a landing site for a static URL, accessible in a content distribution network that is provided by a Domain Name Server, DNS, in which the content distribution network that serves the static .html code with embedded Javascript, and the client returns the answer to the challenge-responses question that is embedded in a URL request.
